(19) United States
(12) Patent Application Publication
(10) Pub. No.: US 2010/0046629 A1
(43) Pub. Date: Feb. 25, 2010

(54) VIDEO DECODING SYSTEM AND METHOD THEREOF

(76) Inventors: Chun-Chia Chen, Hsinchu City (TW); Chi-Cheng Ju, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/193,760

(22) Filed: Aug. 19, 2008

(51) Int. Cl. H04N 11/02; G06K 9/46

(52) U.S. Cl. 375/240.25; 382/233; 375/E07.076; 375/E07.088

(57) ABSTRACT

A video decoding method includes: (a) computing location relations between an original frame and a resized frame to which the frame is to be scaled; (b) mapping a location of a data unit of the original frame to a location of a corresponding data unit of the resized frame according to the location relations; and (c) scaling the data unit of the original frame to the corresponding data unit of the resized frame.

### BACKGROUND OF THE INVENTION

The present invention relates to a video decoding system and method thereof and particularly relates to a video decoding system and method that need no extra reference frame buffer and no extra read operation in RPR mode.

FIG. 1 illustrates a related art video decoding system in a Reference Picture Resampling (RPR) mode. It is noted that the RPR mode, utilized in video standards such as H. 263+ and RealVideo standards, is a mode that allows a video encoder or decoder to change a picture size on a frame-by-frame basis. However, an RPR frame buffer is needed to store the scaled frame and the necessity of this RPR frame buffer increases the related costs.

As shown in FIG. 1, an original frame OF is read from a storage device 101, scaled by a scaler 103, and then the scaled frame SF is stored back to the storage device 101. The scaled frame SF is then read from the storage device 101 to the video encoder 105 for motion compensation. Therefore, two read operations and one write operation are needed, which is time consuming and increases the bandwidth requirement.

### SUMMARY OF THE INVENTION

One embodiment of the present invention discloses a video decoding method, which comprises: (a) computing location relations between an original frame and a resized frame to which the frame is to be scaled; (b) mapping a location of a data unit of the original frame to a location of a corresponding data unit of the resized frame according to the location relations; and (c) scaling the data unit of the original frame to the corresponding data unit of the resized frame.

Another embodiment of the present invention discloses a video decoding system including a location mapping device and a scaler. The location mapping device is for computing location relations between an original frame and a resized frame to which the original frame is to be scaled, and for mapping a location of a data unit of the original frame to a location of a corresponding data unit of the resized frame according to the location relations. The scaler is for scaling the data unit of the original frame to the corresponding data unit of the resized frame.

According to the above-mentioned embodiments, only one read and one write operation are needed, thus time and bandwidth requirements are decreased. Additionally, no reference frame buffer is needed according to the above-mentioned embodiments, and therefore the cost can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a related art video decoding system in a Reference Picture Resampling (RPR) mode.

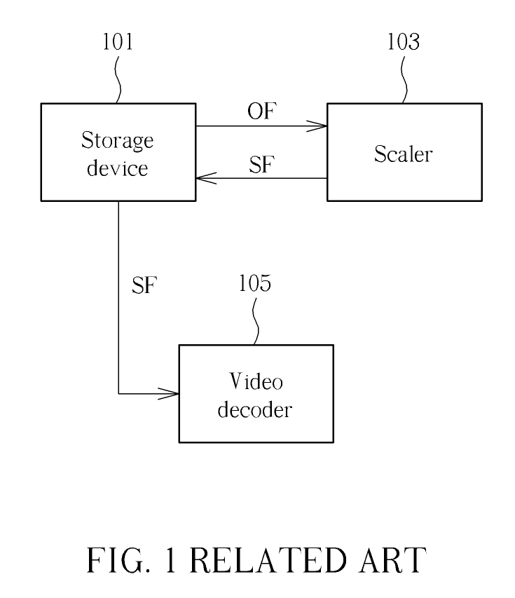

FIG. 2 is a block diagram illustrating a video decoding system according to an embodiment of the present invention.

FIG. 3 is a flow chart illustrating a video decoding method according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

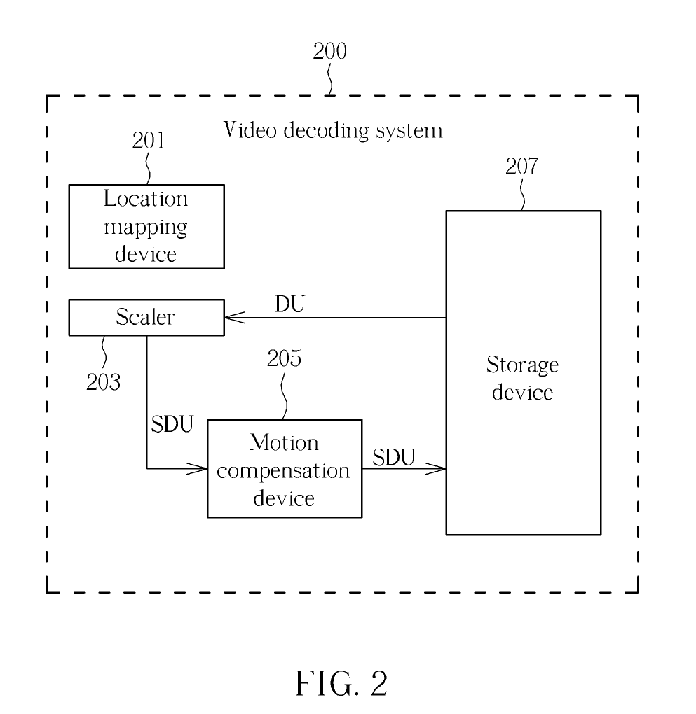

FIG. 2 is a block diagram illustrating a video decoding system 200 according to an embodiment of the present invention. As shown in FIG. 2, the video decoding system 200 includes a location mapping device 201, a scaler 203 and a motion compensation device 205. The location mapping device 201 is arranged for computing location relations between an original frame and a resized frame to which the original frame is to be scaled, and is arranged for mapping a location of a data unit (a macro block in this embodiment) of the original frame to a location of a corresponding data unit of the resized frame according to the location relations.

The scaler 203 is arranged for scaling the data unit DU of the original frame to the corresponding data unit SDU of the resized frame. The location relations can be computed according to the scaling ratio between the original frame and the scaled frame. This technique is well known and details are therefore omitted for brevity.

The video decoding system 200 can include a motion compensation device 205, which is arranged for performing motion compensation on the corresponding data unit of the resized frame without storing the corresponding data unit of the resized frame. In other words, the motion compensation device 205 performs motion compensation on the corresponding data unit SDU of the resized frame on the fly (in real time), thus it is not necessary to store the scaled frame and read it again for scaling. Additionally, in this embodiment the scaler 203 and the motion compensation device 205 are implemented via a single device, that is, the scaler 203 and the motion compensation device 205 can be merged to form a single device.

Furthermore, the video decoding system 200 can further comprise a storage device 207 for storing the corresponding data unit after the motion compensation device 205 performs motion compensation on the corresponding data unit on the fly (in real time). Also, the location mapping device 201, the scaler 203, and the motion compensation device 205 repeatedly process the data units of the original frame until all the data units of the original frame are processed by the location mapping device 201, the scaler 203, and the motion compensation device 205.

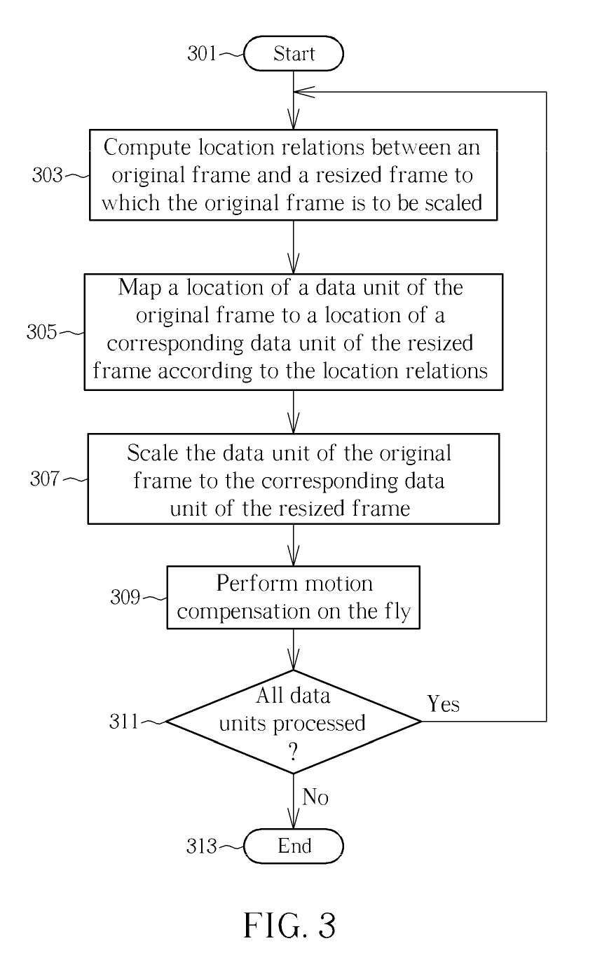

FIG. 3 is a flow chart illustrating a video decoding method according to an embodiment of the present invention. Please jointly refer to FIGS. 2 and 3 and the related descriptions. The video decoding method includes:
Step 301: Start.
Step 303: The location mapping device 201 computes location relations between an original frame and a resized frame to which the original frame is to be scaled
Step 305: The location mapping device 201 maps a location of a data unit (a macro block in this embodiment) of the original frame to a location of a corresponding data unit of the resized frame according to the location relations.
Step 307: The scaler 203 scales the data unit of the original frame to the corresponding data unit of the resized frame.
Step 309: The motion compensation device 205 performs motion compensation on the scaled data unit before storing the scaled data unit (i.e. on the fly).
Step 311: It is checked whether all the data units are processed by the steps 303, 305, and 307. That is, it is checked whether there any data unit of the original frame has not been scaled and motion compensated. If this is true, the method goes back to step 305. If not, the flow ends.
Step 313: End.

Other detailed characteristics of the video decoding method shown in FIG. 3 are described in the embodiment of FIG. 2, and therefore are omitted here for brevity.

According to the above-mentioned embodiments, only one read and one write operation are needed. That is, one read operation is performed on the data unit of the original frame and one write operation is performed on the scaled data unit after motion compensation. Accordingly, time consumption and bandwidth requirements are reduced. Additionally, no reference frame buffer is needed according to above-mentioned embodiments, and therefore cost is reduced.

Those skilled in the art will readily observe that numerous modifications and alterations of the device and method may be made while retaining the teachings of the invention.

What is claimed is:

1. A video decoding method, comprising:
(a) computing location relations between an original frame and a resized frame to which the original frame is to be scaled;
(b) mapping a location of a data unit of the original frame to a location of a corresponding data unit of the resized frame according to the location relations; and
(c) scaling the data unit of the original frame to the corresponding data unit of the resized frame.

2. The video decoding method of claim 1, further comprising:
(d) performing motion compensation on the corresponding data unit of the resized frame without storing the corresponding data unit of the resized frame.

3. The video decoding method of claim 2, wherein the step of scaling the data unit of the original frame to the corresponding data unit of the resized frame and the step of performing motion compensation to the corresponding data unit of the resized frame without storing the corresponding data unit of the resized frame is performed by a single device.

4. The video decoding method of claim 2, further comprising:
(e) storing the corresponding data unit already processed by the step
(d);
wherein the steps (a), (b), (c), (d), and (e) are repeatedly performed until the steps (a), (b), (c), (d), and (e) have been performed on all the data units of the original frame.

5. The video decoding method of claim 1, wherein the data unit is a macro block.

6. A video decoding system, comprising:
a location mapping device, arranged for computing location relations between an original frame and a resized frame to which the original frame is to be scaled, and arranged for mapping a location of a data unit of the original frame to a location of a corresponding data unit of the resized frame according to the location relations; and
a scaler, arranged for scaling the data unit of the original frame to the corresponding data unit of the resized frame.

7. The video decoding system of claim 6, further comprising:
a motion compensation device, for performing motion compensation on the corresponding data unit of the resized frame without storing the corresponding data unit of the resized frame.

8. The video decoding system of claim 7, wherein the scaler and the motion compensation device are implemented via a single device.

9. The video decoding system of claim 6, further comprising a storage device for storing the corresponding data unit after the motion compensation device performs motion compensation on the corresponding data unit, wherein the location mapping device, the scaler, and the motion compensation device repeatedly process the data units of the original frame until all the data units of the original frame have been processed by the location mapping device, the scaler, and the motion compensation device.

10. The video decoding system of claim 6, wherein the data unit is a macro block.
